(19) United States
(12) Patent Application Publication
(10) Pub. No.: US 2003/0088585 A1
(43) Pub. Date: May 8, 2003

(54) Method for non-linear document evaluation

(76) Inventors: Uwe Moeller, Schinznach-Bad (CH); Valborg Wernli, Oberrohrdorf (CH); Walter de Paris, Rheinfelden (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 09/988,309

(22) Filed: Nov. 19, 2001

(30) Foreign Application Priority Data
Nov. 6, 2001 (EP) 01126268.0

(51) Int. Cl. G06F 12/00

(52) U.S. Cl. 707/200

(57) ABSTRACT

A method for evaluating documents is based on filtering documents according to specific interest profiles (a, . . . , g) from the body (1) of existing documents and to assign them and make them available simultaneously to document-specific readers (A, . . . , G). These document-specific readers have the task of evaluating the documents and perform a relevance evaluation. A computer system (4) coordinates the evaluation process by means of a coordination table (5). A document-specific overall relevance is formed from the separate, individual relevance evaluations. Documents with a specific relevance are assigned to a subject-specific decision-making instance (PRO). In one embodiment of the invention, the subject-specific decision-making instance performs a new relevance evaluation. Depending on this evaluation, the subject-specific decision-making instance may initiate differentiated subsequent processes together with an administrative decision-making instance (SPO/SPA).

### FIELD OF TECHNOLOGY

The present invention relates to a method for non-linear document evaluation according to the preamble of claim 1. It furthermore relates to a computer program or computer program system that causes a computer to perform the control of such a method, as well as to data carriers on which this computer program or program system is stored.

### STATE OF THE ART

The volume of information to be made available for use in business, technology, and science has tremendously grown during recent decades and continues to grow steeply. The existing information is contained in a huge number of documents published on a daily basis, whereby the term documents here should be construed to include not only classic print media but in a further sense also radio and TV messages, and in an exponentially increasing volume also, naturally, pages published on the Internet, whereby this list of course should not be understood to be complete. The evaluation of a document is a non-linear process, in which an expert analyzes and potentially processes the information content of a document based on his specific knowledge and indeed also under subjective aspects. The early evaluation, processing and use of this large amount of information, and the resulting ability of being able to respond in a timely manner based on facts that have become known means a remarkable competitive advantage for enterprises and organizations, both with respect to technology and business.

An example that shows this particularly well is the tracking of patent literature. Patents must be analyzed both in terms of content and their relevance for one's own developmental work. This is important in order to avoid that one's own developmental work does not extend into a field protected by patent law and also prevents duplication of developments. A thorough evaluation of the content requires the reading of the document by readers from different subject disciplines so that the content of a patent document can be examined from different viewpoints. The overall relevance of a document is the combined body of evaluations by all readers involved in the evaluation process. However, the process described is also time-critical, since deadlines may have to be kept.

A classic method for reading documents consists of circulating each document identified by way of an interest profile, based, for example, on the IPC classification, among a document-specific pool of readers in printed form, whereby the association of the documents with a pool of readers also is based on predefined criteria and can be understood as part of the interest profile. In one successful version, the relevance evaluations of the individual, document-specific readers are recorded in such a way on a list that is part of the circulating document itself that, after the completed circulation, the combined body of all evaluations is available in summarized form. The highest relevance will show a document-specific relevance. Documents evaluated as highly relevant are supplied in a next step to a subject-specific decision-making instance that initiates further procedure. Other documents categorized as less relevant are archived, while the documents categorized as non-relevant are recycled.

If the necessary organization is available, the described method is firstly easy to manage, and in practice also was found to be efficient with respect to a realistic evaluation of the relevance level of the documents for now.

At the same time, the described method also has disadvantages. On the one hand, a large number of patent documents are distributed in full text to the document-specific readers. Experience shows that more than half of these documents are categorized as non-relevant by all readers even after an analysis of just the abstract and the relevant figure. Another limitation of the—linearized—preselection made, for example, via IPC classifications or keyword combinations, is however associated with a high risk that a significant number of highly relevant documents are not covered with the non-linear analysis by the readers.

Another disadvantage should be seen in the fact that the reading of the documents by the individual readers takes place only serially, in other words, only one reader at a time is able to work on a document. But especially when a document is found to be potentially relevant, which per se will be associated with, and justify, more efforts for analyzing a document, strict deadlines will apply so that the individual reader only will have available a very limited amount of time. In addition, the timely return of the documents to a required coordination instance is very difficult to monitor.

### DESCRIPTION OF THE INVENTION

It is the objective of the invention to disclose a method of the aforementioned type that avoids the above-mentioned disadvantages.

This objective is realized according to the invention within the entirety of characteristics of claim 1.

This means that it is the core of the invention to simultaneously make available the documents to all document-specific readers. In a preferred embodiment, all document-specific readers initially simultaneously receive the document at a lower detail level, for example, in the form of an abstract that may also be supplemented with one or more drawings. If a reader categorizes a document as potentially relevant or, in any case, as not irrelevant based on the information contained at the lowest detail level, a higher detail level of the document is made available on request, up to the complete document. The parallel, simultaneous reading of the document is tracked with the help of a coordination table. Ideally, it is noted in the coordination table which document was made available to which reader at what time. Furthermore, entries are made after a reader has read and evaluated a document, to the effect that a document is recorded as evaluated once it has been read and evaluated by all document-specific readers. If required, a time limit specifying by when a document should have been read and evaluated by all document-specific readers can be set and verified using corresponding entries in the coordination table; this means that a reminder can be sent to a reader within a specified time period prior to this time limit. It is also possible to record in the coordination table whether a copy of a requested full text document is already available or still must be obtained externally.

Overall, the coordination table plays a central role in the implementation of a method according to the invention. The technical solution of this objective in particular can be seen in that a coordination table preferably is maintained on a computer system accessible to all readers; which makes it possible to implement and monitor a parallel reading of the document. In a coordination table, a relevance evaluation of the documents performed by the readers can be recorded, whereby the highest relevance attributed by a reader to a document then is the document-specific relevance. It is hereby advantageous if the relevance evaluation is undertaken in a grid of predefined relevance levels.

In a version of the method according to the invention, a specific relevance level in a relevance evaluation will trigger a new procedure. The document may be resubmitted to a subject-specific decision-making instance that will also become the process owner for the further procedure. A strict preselection of the documents already was undertaken prior to reaching this decision-making instance. The decision-making instance performs another relevance evaluation and decides on further procedure. The new relevance evaluation replaces the original document-specific relevance evaluation; naturally, documents previously evaluated as highly relevant may be identified as not being relevant after all.

Documents categorized below a certain relevance level are discarded; the other documents are archived and are made available to a broad pool of readers, preferably with the relevance evaluation.

The documents are made available and archived in electronic form. A document may hereby be stored at different detail levels, whereby the corresponding files are linked with each other by symbolic pointers stored in the coordination table and/or contain references to each other. In this connection, it is also very advantageous to maintain the coordination in electronic form. As described above, the coordination table may contain a number of information criteria that may be significant for the process flow, and it would be advantageous that it can be sorted according to these criteria. In this sense, an electronically maintained coordination table not only represents a two-dimensional table but is actually a database, particularly a relational database. Information contained in the coordination table need not necessarily be stored directly in the coordination table, but also may be contained simply in the form of logical references and symbolic pointers to other files.

If, as shown above, the documents are made available in electronic form on a computer system, it is sensible to file document-specific information in a uniform data form in the computer system and display it to the users. Document-specific entries also can be made directly in such a data form. The identity of the user making the entry and his authorization to make entries hereby can be verified in the computer system. These additional entries then can be recorded in the coordination table. In this sense, the data form represents an input and output interface of the coordination table.

In the electronic embodiment of the method, it is furthermore an advantage if at least one detail level of each document is available in electronically researchable form so that the documents are accessible for subject research.

The method very advantageously can be combined with an electronic mail system by informing each reader, for example, by notification through an electronic mail system, when a new document for reading is available for him. In the same way, the reminder system may be automatically initiated via this mail system when a time limit approaches, and the readers will be able to return their evaluation in this way to the coordination instance, whereby the evaluation is recorded directly in the coordination table. Storage in an electronically maintained coordination table makes it possible to automate these steps.

A significant advantage of the invention is that as a result of the parallel document evaluation, the individual reader has more time available for a detailed analysis and evaluation of a potentially relevant document within a set period of time. Another advantage of the invention is that, by only distributing versions of the document at a low detail level used for a first preselection in a first step, the information flood to which the individual reader is exposed is clearly reduced, which again permits a higher-quality analysis of the potentially relevant documents. This procedure also significantly reduces costs incurred in the acquisition of complete documents of the highest detail level.

Another advantage of the method is that, if the method is performed using a computer system and documents in electronic form, the entire process can be easily monitored and controlled by suitable means. A significant number of process steps may take place automatically, in particular because the status is documented in the coordination table. The preselected documents with their evaluations and comments also can be made available in a simple manner for a large pool of readers, which represents a substantial added value especially in large enterprises. In this connection, internal documents of an organization, more specifically, of an enterprise, also may be made accessible to the readers. For example, a broad pool of readers within an enterprise can be informed about the newest developments by way of an internal notification of filed patent applications that constitute a priority, before the application is actually publicly disclosed. Hereby the possibility of limiting the authorized pool of readers in a document-specific manner should be used, if required.

As has already been suggested, the method according to the invention is particularly suitable for evaluating documents available in electronic form, and can be implemented advantageously on a computer or computer system. For this reason, protection is also sought for a computer program or a computer program system for performing the respective control of a method according to the invention. Protection is sought for data carriers on which such a computer program or program system is stored in the form of source text as well as executable code. The term data carriers hereby should be understood in the furthest possible sense; in particular, this includes a bundle of several data carriers. Every computer-readable and/or writable medium is potentially suitable for this purpose. This would also include volatile storage, such as RAM memory that contains such computer code as source text or in executable form. In particular, it also includes the working memory (RAM) of a computer on which a corresponding computer program is loaded.

### BRIEF DESCRIPTION OF DRAWING

The invention is explained in more detail below in reference to examples illustrated in the drawing. In detail:

FIG. 1 shows the information flow between the functional units involved in a method according to the invention;

FIG. 2 shows a flow chart of a method according to the invention;

FIG. 3 shows a schematic view of the coordination table.

The exemplary embodiments must not be interpreted in a limiting sense but are used only for a better understanding of the invention characterized in the claims.

### Way of Executing the Invention

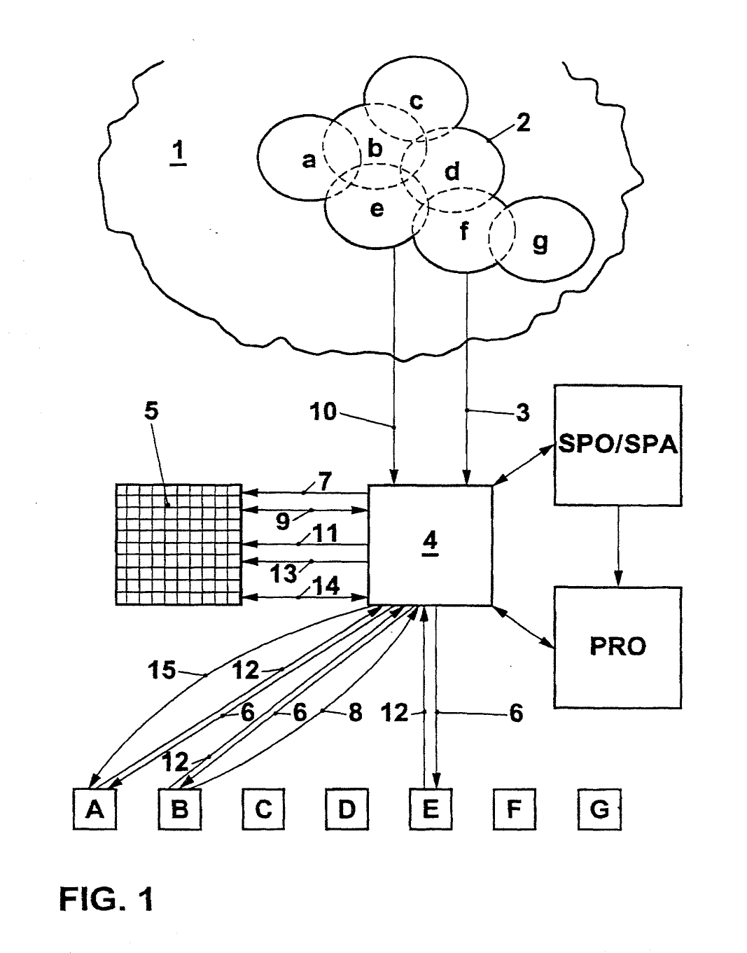

A very schematic example for the data flow during the evaluation of a document is shown by means of a method according to the invention in FIG. 1. The volume designated with reference number 1 represents the patents and Offenlegungsschriften [unexamined patent applications] filed within a certain time frame, for example, within the last four weeks. Readers A, B, C, D, E, F, G have defined for themselves interest profiles a, b, c, d, e, f, g that may partially overlap, and the combined body of which describes the interest profile 2 of an organization. All documents of the intersection between the documents 1 and the entire interest profile 2 must be evaluated. In a first step, the abstracts 3 of these documents, if available, with relevant drawings, are loaded onto a computer system 4. A document is hereby made available with information indicating the interest profile with which it has been associated. The computer system creates a data record containing, among other information, bibliographic data of the document in the coordination table 5 for a newly supplied document. In the shown case, a document corresponds to interest profiles a, b and e. Via an electronic mail system, the computer system 4 initiates the transmission of notifications 6 to document-specific readers A, B, and E. At the same time, an entry 7 is made in the coordination table to the effect that an evaluation by these readers is needed. The document is now available to these readers at a low detail level. Reader B recognizes the document as potentially relevant based on this information. For better assessment, he orders the full text document by way of a message 8. The computer system 4 checks via dialog 9 with the coordination table whether this full text document is already available. If it is not available, the computer system 4 loads the document 10, and a corresponding entry 11, in the form of a symbolic pointer to the stored full text document, is made in the coordination table; if another reader then also wants this full-text document, it can be made available to him immediately on request. If a document-specific reader has read a document, he sends a feedback message 12 to the computer system, and a corresponding entry 13 is made in the coordination table. The feedback message and the entry contain an evaluation of the relevance of the document by the document-specific readers. If time-critical documents are at issue, the entries in the coordination table include response times that are checked regularly by the computer system by means of a verification dialog 14 with the coordination table until all readers have sent a feedback message, i.e., until a relevance evaluation is present in the coordination table for each document-specific reader. If no complete response has been made within an appropriate, specified time limit, reminders are sent to the readers who are late. If reader A has not sent a timely evaluation, he will receive a reminder 15 until he also has submitted a relevance evaluation for the document. Once the relevance evaluation is complete, the document is routed to a subject-specific decision-making instance PRO if it has a high relevance. Depending on the document type and document relevance, this subject-specific decision-making instance may initiate very differentiated additional processes, in which the coordination table also plays a central role in the documentation of the process and the status of the process. In addition, to the subject-specific decision-making instance PRO, there is a secondary administrative decision-making instance SPO/SPA. The administrative decision-making instance SPO/SPA is authorized to request a new categorization of the relevance from the subject-specific decision-making instance PRO before subsequent processes are initiated, in particular prior to the initiation of cost-producing processes; this is done in particular in consideration of the fact that subsequent processes are designed for the long-term, while the technical and economical underlying conditions in whose context a relevance categorization takes place are highly dynamic and subject to continuous changes. In particular, the administrative decision-making instance SPO/SPA in one embodiment of the invention is also authorized to determine the subject-specific decision-making instance PRO. Another important point of the method according to the invention is the storage of documents in a form in which both the documents themselves as well as the comments and evaluations are accessible to a broad pool of readers; the documents are hereby stored preferably in a searchable manner in such a way that the archived documents are also accessible to a subject search.

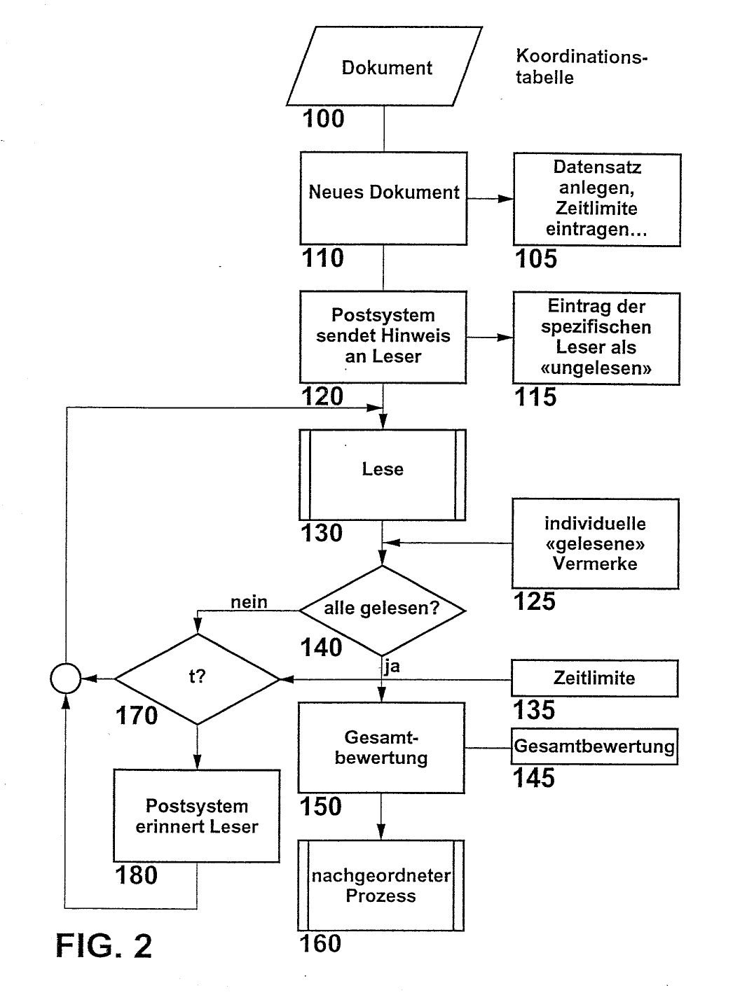

FIG. 2 shows a flow chart of a schematically shown process. The right column shows the events of the coordination table. A first functional block 100 acquires a new document. A functional block 110 then stores it and makes a first entry 105 in the coordination table. In the process, a data record associated with the new document is created, and bibliographic data, a pointer to the new document, as well as other relevant data, such as a deadline for completing the document evaluation, are entered. In a next functional block 120, an electronic mail system automatically sends notifications of the new document to the document-specific readers. In particular at this point, the method according to the invention may be integrated advantageously into an existing electronic mail system, e.g., based on Lotus Notes. At the same time, an entry 115 of the specific readers as “unread” is made in the coordination table. In a next step, the reading process 130, which is a sub-process that per se is not further detailed within this framework, begins. At regular time intervals, for example, daily, the individual “read” entries 125 of the readers are queried in the coordination table, and a functional block 140 is checked to see whether all document-specific readers have already completed their evaluation and have entered it in the coordination table. If this is not the case, a next step 170 verifies whether a document-specific response deadline, stored as time limit 135 in the coordination table, has already been reached or exceeded. If this is the case, late readers are reminded by means of the electronic mailing system, and the reading process is continued until the query 140 is answered affirmatively. Then, in process step 150, the overall evaluation is made, and the resulting document-specific relevance evaluation 145 is stored in the coordination table. Then, dependent on the completed relevance categorization, a subsequent process 160 is initiated.

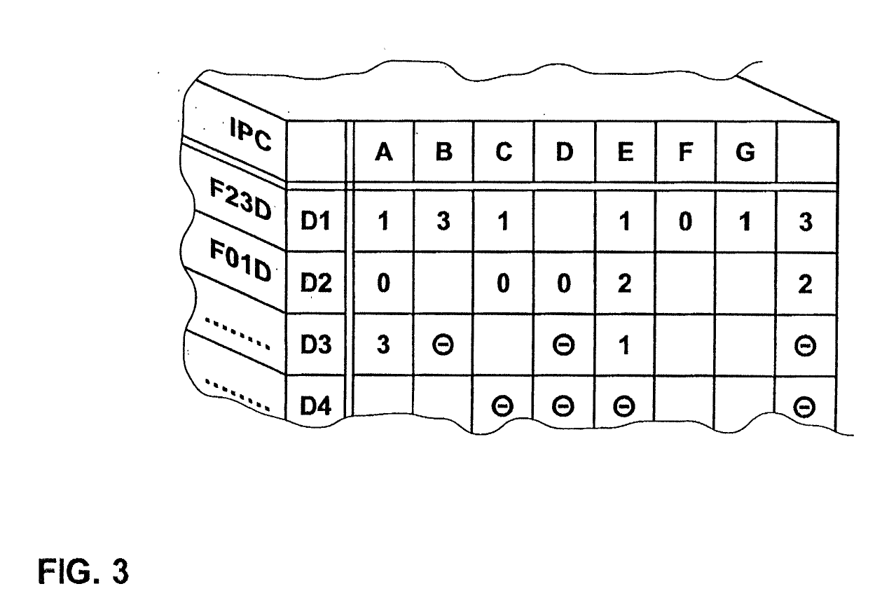

As can be seen implicitly from the above explanations, the coordination table is in no way limited to a two-dimensional table. A schematic example of a coordination table is shown in FIG. 3. On the sheet level, documents D1, D2, D3, D4, . . . are entered on a vertical axis; the columns are assigned to the readers, and the overall evaluation of the document is noted in the last column. If a document is not associated with the interest profile of a reader, the corresponding cell in the table remains empty. A “-” stand for a note indicating “unread” or “to be read”. During the readers' evaluation, this note is replaced with their evaluations. The sample table shown should be understood to indicate that the document-specific readers of document D1 are A, B, C, E, F, and G; that all have submitted their evaluation, and that overall evaluation 3 has been the result. The document-specific readers of D3 are A, B, D, and E; A and E have submitted their evaluation; the evaluation by B and D is still pending so that no overall evaluation could be made yet. On an axis projecting into the sheet level, other information, such as the IPS classification, is listed. Other important information includes, for example, the holder of the patent, publication date, or a pointer to the abstract and full text of the document. The coordination table advantageously is a multidimensional database. This makes it possible to easily analyze and evaluate its data depending on a large amount of other information.

The exemplary embodiments should be understood as being only instructive and in no way limiting, and are only able to partially demonstrate the possibilities of the method characterized in the claims. However, for the interested expert a large number of possible embodiments of the invention characterized in the claims will be revealed in this light.

List of Reference Numerals

| | |
|---|---|
| 1 | Body of information available overall |
| 2 | Interest profile of all readers A . . . G |
| 3 | Document abstracts |
| 4 | Computer system |
| 5 | Coordination table |
| 6 | Notification |
| 7 | Entry |
| 8 | Message, request |
| 9 | Dialog |
| 10 | Document |
| 11 | Entry |
| 12 | Feedback message, acknowledgement |
| 13 | Entry, acknowledging entry, “read” note |
| 14 | Verification dialog |
| 15 | Reminder |
| A, . . . , G | Reader |
| a, . . . , g | Individual interest profiles of readers A, . . . , G |
| PRO | Subject-specific decision-making instance |
| SPO/SPA | Administrative decision-making instance |

1. Method for non-linear document evaluation comprising the following steps:
documents (a, . . . , g) are associated with document-specific readers (A, . . . , G);
the documents are made available to all document-specific readers (A, . . . , G) simultaneously;
a note (7) regarding which document was made available to which reader is made in a coordination table (5);
once a reader has read and evaluated a document, another note (13) is made in the coordination table;
once all document-specific readers have read and evaluated a document, a note to this effect is made in the coordination table.

2. Method as claimed in claim 1,
whereby the documents first are made available at a low detail level (3), and a reader is provided on request with a higher detail level (10) of a document.

3. Method as claimed in one of the previous claims, whereby document-specific time limits are set and a document-specific reader receives a reminder (15) within a defined time period prior to the end of the time limit.

4. Method as claimed in one of the previous claims, whereby the document-specific readers perform a relevance evaluation that is recorded in the coordination table, and whereby a document-specific relevance score is formed from the completed evaluation with the highest relevance.

5. Method as claimed in claim 4, whereby the documents are routed to a subject-specific decision-making instance (PRO) starting with a certain specified relevance score, and whereby this decision-making instance performs a new relevance evaluation, and, based on this new relevance evaluation, a subsequent process is initiated as needed.

6. Method as claimed in claim 5, whereby the new relevance evaluation replaces the original, document-specific relevance evaluation.

7. Method as claimed in one of claims 5 or 6, whereby an administrative decision-making instance (SPO/SPA) that is secondary to the subject-specific decision-making instance (PRO) requests a new relevance evaluation from the subject-specific decision-making instance (PRO) prior to initiating a subsequent process, particularly before initiating a cost-producing subsequent process.

8. Method as claimed in one of claims 4 to 7, whereby the documents are discarded according to the document-specific relevance or are stored in relevance-related archives.

9. Method as claimed in claim 8, whereby the stored documents, preferably with the relevance evaluation, are made accessible to a broad pool of readers.

10. Method as claimed in claim 9, whereby internal documents of an organization, in particular patent applications filed so as to constitute a priority, are made accessible.

11. Method as claimed in one of the previous claims, whereby the documents are made available in electronic form and possibly are stored in the relevance-related archives.

12. Method as claimed in claim 11, whereby the documents are stored in different detail levels that are linked with each other by way of symbolic pointers and/or are provided with cross-references.

13. Method as claimed in one of the previous claims, whereby document-specific information is stored and displayed in a uniform data form on a computer system.

14. Method as claimed in claim 13, whereby document-specific entries are made directly in the data form.

15. Method as claimed in claim 14, whereby the identity of the user making the entry and his authorization for making entries in certain form fields are verified.

16. Method as claimed in one of claims 14 or 15, whereby the entries are recorded in the coordination table.

17. Method as claimed in one of claims 11 to 16, characterized in that at least one detail level of a document is available in researchable form.

18. Method as claimed in one of the previous claims, which is integrated into an electronic mail system.

19. Method as claimed in of the previous claims, which is integrated on a distributed, heterogeneous computer system.

20. Computer program or program package that causes a computer to perform or control a method as claimed in one of the previous claims.

21. Data carrier, on which a computer program or computer program package as claimed in claim 20 is stored as source text and/or as executable computer code.
